(19) United States
(12) Patent Application Publication
(10) Pub. No.: US 2013/0215008 A1
(43) Pub. Date: Aug. 22, 2013

(54) PORTABLE ELECTRONIC DEVICE AND CONTROL METHOD THEREOF

(71) Applicant: Li-Te HUNG, Taipei City (TW)

(72) Inventor: Li-Te HUNG, Taipei City (TW)

(73) Assignee: QUANTA COMPUTER INC., Tao Yuan Shien (TW)

(21) Appl. No.: 13/484,484

(22) Filed: May 31, 2012

(30) Foreign Application Priority Data
Feb. 21, 2012 (TW) 101105703

(51) Int. Cl. G06F 3/01

(52) U.S. Cl. 345/156

(57) ABSTRACT

A portable electronic device including a base, a lid and a hinge is provided. The base has a control unit and a proximity sensor. The proximity sensor is electrically connected to the control unit. The lid has a panel electrically connected to the control unit. The hinge is used for connecting the base with the lid. When the proximity sensor detects that the angle between the lid and the base exceeds a predetermined angle, the control unit performs a predetermined operation.

This application claims the benefit of Taiwan application Serial No. 101105703, filed Feb. 21, 2012, the subject matter of which is incorporated herein by reference.

### BACKGROUND OF THE INVENTION

1. Field of the Invention

The disclosure relates in general to a portable electronic device and a control method thereof.

2. Description of the Related Art

When a user would like to share the contents of a conventional laptop computer with someone, the user has to turn the laptop computer to face the particular person or perform additional setting for manually sharing the contents to an external display. Such sharing is really inconvenient to the user.

### SUMMARY OF THE INVENTION

The disclosure is directed to a portable electronic device and a control method thereof in which the opened angle of a panel is detected by a proximity sensor and a corresponding predetermined operation is performed automatically.

According to a first aspect of the present disclosure, a portable electronic device including a base, a lid and a hinge is provided. The base has a control unit and a proximity sensor. The proximity sensor is electrically connected to the control unit. The lid has a panel electrically connected to the control unit. The hinge is used for connecting the base with the lid. When the proximity sensor detects that the angle between the lid and the base exceeds a predetermined angle, the control unit performs a predetermined operation.

According to a second aspect of the present disclosure, a method for controlling a portable electronic device is provided. The portable electronic device includes a base, a lid and a hinge. The base has a control unit and a proximity sensor electrically connected to the control unit. The lid has a panel electrically connected to the control unit. The hinge is used for connecting the base with the lid. The method for controlling a portable electronic device includes the following steps. The angle between the lid and the base is detected by a proximity sensor. When the proximity sensor detects that the angle between the lid and the base exceeds the predetermined angle, the control unit performs a predetermined operation.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of an example of a portable electronic device according to an embodiment;

FIG. 2 shows a block diagram of an example of a portable electronic device according to an embodiment; and

FIG. 3 shows a block diagram of another example of a portable electronic device according to an embodiment.

### DETAILED DESCRIPTION OF THE INVENTION

The disclosure provides a portable electronic device and a control method thereof, in which the open angle of a panel is detected by a proximity sensor and a corresponding predetermined operation is performed automatically so as to increase the convenience of use.

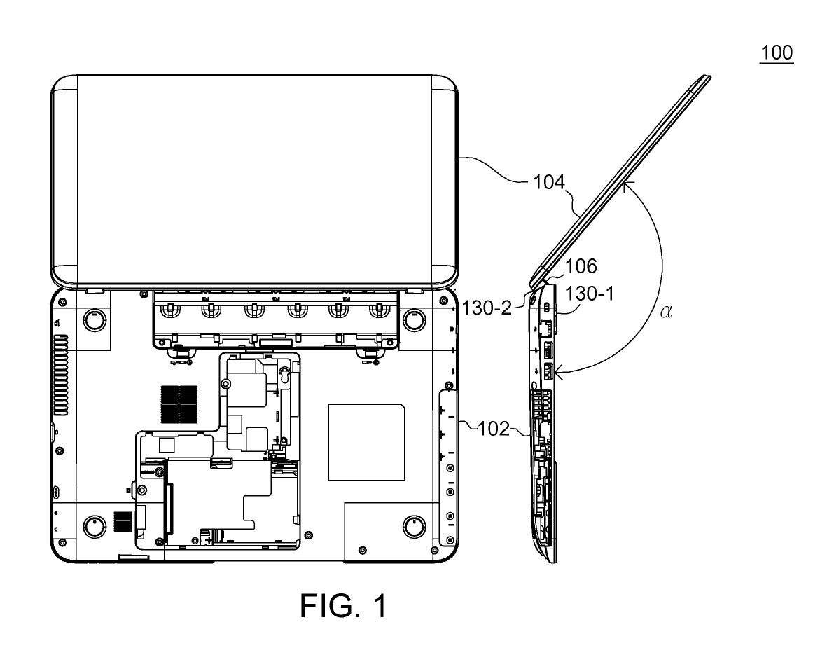

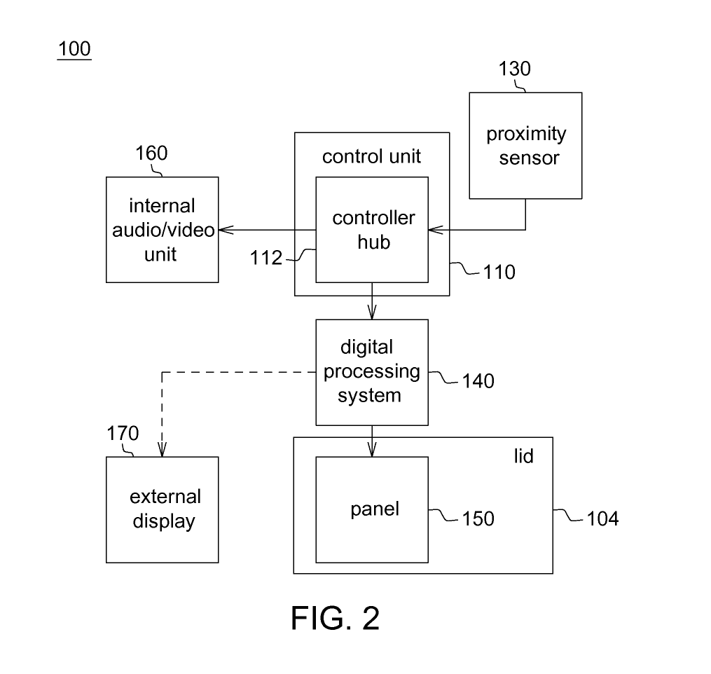

Referring to FIG. 1 and FIG. 2. FIG. 1 shows a schematic diagram of an example of a portable electronic device according to an embodiment. FIG. 2 shows a block diagram of an example of a portable electronic device according to an embodiment. The portable electronic device 100, such as a laptop computer, includes a base 102, a lid 104 and a hinge 106. The base 102 has a control unit 110, a proximity sensor 130 and a digital processing system 140. The proximity sensor 130 and the digital processing system 140 are electrically connected to the control unit 110 respectively. The lid 104 has a panel 150 electrically connected to the digital processing system 140. In an implementation, the digital processing system 140 is an optional element. That is, the control unit 110 could be electrically connected to the panel 150 directly for switching the ON/OFF state of the panel. In an implementation, the digital processing system 140 is integrated in the control unit 110.

The hinge 106 is used for connecting the base 102 and the lid 104, so that the lid 104 is able to be opened or closed with respect to the base 102. As indicated in FIG. 1, the proximity sensor 130 may be located on the top side of the base 102 (such as at position 130-1) for detecting whether the lid 104 is closed with respect to the base 102. In an exemplary embodiment, if the hinge 106 is a sink-type hinge, then the proximity sensor 130 may be located on a lateral side of the base 102 connecting the lid 104 (such as at position 130-2) for detecting whether the lid 104 is opened with respect to the base 102. The proximity sensor 130 may be realized by an infra-red sensor, capacitive sensor or an electromagnetic sensor according to the design needs. The proximity sensor 130 determines the angle α between the lid 104 and the base 102 according to the intensity of the beam, which is emitted by the proximity sensor 130, reflected from the lid 104.

In the present embodiment, the control unit 110 includes a controller hub 112 realized by such as a platform controller hub (PCH) or a fusion controller hub (FCH) according to the design architecture of the control unit 110.

The portable electronic device 100 substantially may perform setting with a basic I/O system (BIOS) coupled to the controller hub 112 or an application program stored in a hard disc to perform a predetermined operation according to the proximity sensor 130. When the proximity sensor 130 detects that the angle α between the lid 104 and the base 102 exceeds a predetermined angle, such as 135° or 180°, the controller hub 112 of the control unit 110 performs a predetermined operation.

In an example, when the proximity sensor 130 detects that the angle α between the lid 104 and the base 102 exceeds a predetermined angle, such as 135°, the control unit 110 determines that the user would like to share the contents displayed on the panel 150 with the person sitting opposite to the user. Accordingly, the control unit 110 rotates the contents displayed on the panel 150 for 180° which is a suitable angle for the person opposite to the user to view the displayed contents.

In another example, the portable electronic device 100 further includes an internal audio/video unit 160. The internal audio/video unit 160 is not a necessary element, and may be realized by such as a microphone or a video camera. When the proximity sensor 130 detects that the angle α between the lid 104 and the base 102 exceeds a predetermined angle, the control unit 110 determines that the user would like to have a conference meeting. Accordingly, the control unit 110 activates the internal audio/video unit 160.

In another example, when the portable electronic device 100 plays a film or movie, and the proximity sensor 130 detects that the angle α between the lid 104 and the base 102 exceeds a predetermined angle, the control unit 110 determines that the user would like to share the film with others around the user. Accordingly, the control unit 110 increases the volume level of the control unit 110 so that those around the user can hear the audio sound clearly.

In another example, the digital processing system 140 is electrically connected to an external display 170 such as a high-definition multimedia interface (HDMI) display, a video graphic array (VGA) display or a display port (DP) display. When the proximity sensor 130 detects that the angle α between the lid 104 and the base 102 exceeds a predetermined angle, the control unit 110 determines that the user would like to use the contents displayed on the panel 150 for briefing purpose. Accordingly, the control unit 110 activates the briefing mode, and controls the digital processing system 140 to switch the contents displayed on the panel 150 to be displayed on an external display.

The above examples of predetermined operation may be implemented individually or as a combination accordingly to actual needs.

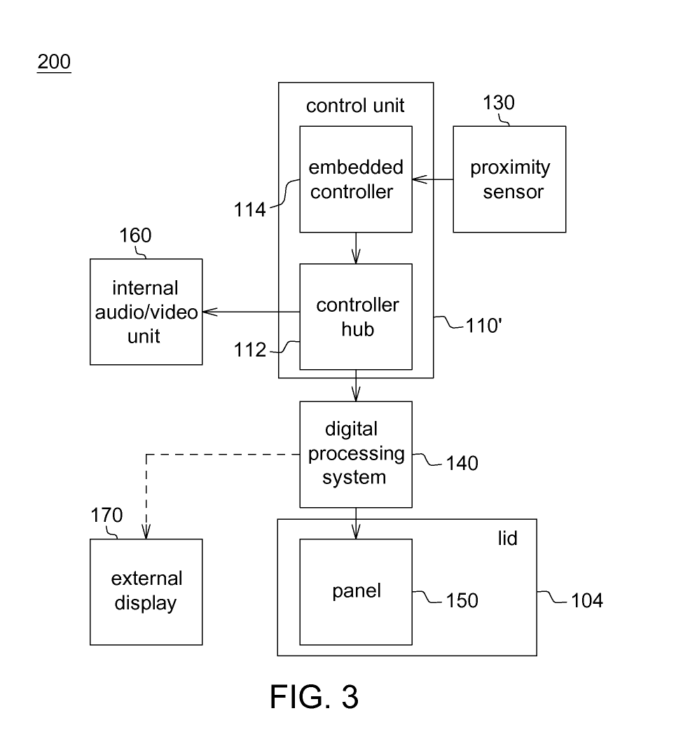

Referring to FIG. 3, a block diagram of another example of a portable electronic device according to an embodiment is shown. The structure of the portable electronic device 200 is similar to that of the portable electronic device 100, and the only difference lies in the control unit 110′. In comparison to the control unit 110, the control unit 110′ further includes an embedded controller 114 electrically connected to the proximity sensor 130. The controller hub 112 is electrically connected to the embedded controller 114 and the digital processing system 140. The design architecture of the control unit 110 is dependent on the design needs. When the proximity sensor 130 detects that the angle α between the lid 104 and the base 102 exceeds a predetermined angle, such as a 135° or 180°, the embedded controller 114 informs the controller hub 112 to perform a predetermined operation.

The disclosure provides a method for controlling a portable electronic device, which includes a base, a lid and a hinge. The base has a control unit, a proximity sensor and a digital processing system. The proximity sensor and the digital processing are is electrically connected to the control unit. The lid has a panel electrically connected to the digital processing system. The hinge is used for connecting the base with the lid. The method for controlling a portable electronic device includes the following steps. The angle between the lid and the base is detected by a proximity sensor. When the proximity sensor detects that the angle between the lid and the base exceeds the predetermined angle, the control unit performs a predetermined operation.

The principles of the method for controlling a portable electronic device are disclosed in the descriptions of the portable electronic devices 100 and 200 and associated contents, and are not repeated here.

According to the portable electronic device and control method thereof of the disclosed embodiments of the disclosure, the opened angle of a panel is detected by a proximity sensor and corresponding operation(s) is performed automatically without employing extra manual setting, so that the convenience of use is increased.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable electronic device, comprising:
a base having:
a control unit; and
a proximity sensor electrically connected to the control unit;
a lid having:
a panel electrically connected to the control unit; and
a hinge used for connecting the base and the lid;
wherein, when the proximity sensor detects that a angle between the lid and the base exceeds a predetermined angle, the control unit performs a predetermined operation.

2. The portable electronic device according to claim 1, wherein the proximity sensor is located on the top side of the base.

3. The portable electronic device according to claim 1, wherein the hinge is a sink-type hinge, and the proximity sensor is located on a lateral side of the base connecting the lid.

4. The portable electronic device according to claim 1, wherein when the angle between the lid and the base exceeds the predetermined angle, the control unit rotates the contents displayed on the panel for 180°.

5. The portable electronic device according to claim 1, wherein the portable electronic device further comprises an internal audio/video unit activated by the control unit when the angle between the lid and the base exceeds the predetermined angle.

6. The portable electronic device according to claim 1, wherein when the angle between the lid and the base exceeds the predetermined angle, the control unit increases the volume level.

7. The portable electronic device according to claim 1, wherein when the angle between the lid and the base exceeds the predetermined angle, the control unit switches the contents displayed on the panel to an external display.

8. A method for controlling a portable electronic device comprising a base, a lid and a hinge, wherein the base has a control unit and a proximity sensor electrically connected to the control unit, the lid has a panel electrically connected to the control unit, the hinge is used for connecting the base and the lid, and the method for controlling a portable electronic device comprises:
detecting the angle between the lid and the base by the proximity sensor; and
performing a predetermined operation by the control unit when the proximity sensor detects that the angle between the lid and the base exceeds a predetermined angle.

9. The method for controlling a portable electronic device according to claim 8, further comprising:
rotating the contents displayed on the panel for 180° by the control unit when the angle between the lid and the base exceeds the predetermined angle.

10. The method for controlling a portable electronic device according to claim 8, wherein the portable electronic device further comprises an internal audio/video unit, and the method for controlling a portable electronic device further comprises:
activating the internal audio/video unit by the control unit when the angle between the lid and the base exceeds the predetermined angle.

11. The method for controlling a portable electronic device according to claim 8, further comprising:
increasing the volume level by the control unit when the angle between the lid and the base exceeds the predetermined angle.

12. The method for controlling a portable electronic device according to claim 8, further comprising:
switching the contents displayed on the panel to an external display by the control unit when the angle between the lid and the base exceeds the predetermined angle.
